(19) United States
(12) Patent Application Publication
(10) Pub. No.: US 2013/0018787 A1
(43) Pub. Date: Jan. 17, 2013

(54) ATM PROVIDED PAYMENT PROCESS

(71) Applicants: Charles Dominic Andrews, Huntersville, NC (US); Scott A. Weigman, Charlotte, NC (US); Matthew A. Calman, Charlotte, NC (US)

(72) Inventors: Charles Dominic Andrews, Huntersville, NC (US); Scott A. Weigman, Charlotte, NC (US); Matthew A. Calman, Charlotte, NC (US)

(73) Assignee: Bank of America Corporation, Charlotte, NC (US)

(21) Appl. No.: 13/215,880

(22) Filed: Aug. 23, 2011

Related U.S. Application Data
(60) Provisional application No. 61/507,951, filed on Jul. 14, 2011.

(51) Int. Cl. G06Q 40/00

(52) U.S. Cl. 705/43

(57) ABSTRACT

System, method, and computer program product are provided for a user to send and receive P2P payments using an ATM machine. Through the use of an ATM, a user may access accounts the user has at a financial institution and direct payments to other individuals or entities from the ATM using those accounts. In this way, the user may ensure a secure payment to a third-party through the network associated with the financial institution and ATM. The payments may be directed to individuals the user may input into the system or to pre-established entities. This invention allows a user to receive and provide payments for any type of transaction utilizing the security, accuracy, and convenience provided to the user by an ATM.

### CLAIM OF PRIORITY UNDER 35 U.S.C. §119

This Non-provisional Patent Application claims priority to Provisional Patent Application Ser. No. 61/507,951 titled “ATM Payment System and Method” filed Jul. 14, 2011, assigned to the assignee hereof and herby expressly incorporated by reference herein.

### BACKGROUND

With the wide adoption of credits cards, debit cards, electronic payment devices, online shopping systems, and online banking systems, very few people today carry cash or write many checks. However, people still need to transfer money to each other for all sorts of reasons. For example, a person may want to pay a friend back for money recently borrowed from the friend, or a person may want to send money to a relative as a gift. Giving or lending money to another person, however, can be difficult when you don't have cash on hand and/or if the person is not physically present. The process may need to involve mailing the person a check, which can be time consuming and inconvenient depending on the situation.

Money can be transferred from one person to another using electronic banking systems, but these systems traditionally require both Internet access and that the sender know account information for the receiver in order to instruct the bank to transfer money to the proper account. Most people do not know the account numbers of their friends or business entities with whom they transact, nor do most people want to widely publicize their account numbers for security reasons. Furthermore, some people do not have regular access to the Internet.

There thus is a need for improved user-friendly systems and methods for transferring money between two people and/or other entities, especially if such systems can transfer money directly to and/or from financial institution accounts, such as demand deposit accounts (e.g., checking accounts), savings accounts, and/or credit accounts.

### BRIEF SUMMARY

Embodiments of the present invention address these and/or other needs by providing an innovative person-to-person (P2P) payment system utilizing established Automated Teller Machine (ATM) functionality for sending and receiving P2P payments. Advantageously, embodiments of the invention do not necessarily require users to share confidential account information with others in order to send and receive payments. In fact, embodiments of the invention do not require that the payment sender know any information about the financial accounts of the intended payment receiver. In this way, embodiments of the invention enable users to make payments to persons that are not customers of the same financial institution and to persons that are not customers of any financial institution.

Furthermore, embodiments of the invention do not necessarily require users to have access to the Internet, for online banking. The P2P payment system utilizes the network and functionality of ATM systems to process, send, and receive P2P payments. Embodiments of the invention also create a “viral” account opening and payment system registration process whereby one person's use of the system encourages others to use the system.

More specifically, embodiments of the invention allow an entity to transfer funds to another entity using an ATM. The entity may provide a mobile telephone number, electronic mail (email) address, a selection of known receivers, and/or other alias of the transfer receiver to determine the entity to direct the payment. The assignee of the present application describes some embodiments of such an invention in U.S. Provisional Patent Application No. 60/991,172, filed on Nov. 29, 2007, and co-pending U.S. patent application Ser. No. 12/038,177, filed on Feb. 27, 2008, as well as in U.S. patent application Ser. Nos. 12/881,071, 12/881,073, 12/881,074, and 12/881,080 continuing therefrom. Embodiments of the present invention include and build off of those earlier embodiments to provide an improved P2P payment system and a more user-friendly, secure, and convenient user interface and method.

Furthermore, embodiments of the invention include and build off of the following applications sharing a common assignee with the present application: U.S. Provisional Patent Application No. 61/410,085, filed on Nov. 4, 2010; U.S. Provisional Patent Application No. 61/410,087, filed on Nov. 4, 2010; U.S. Design patent application No. 29/378,420, filed on Nov. 4, 2010; and U.S. Design patent application No. 29/378,418, filed on Nov. 4, 2010, and as such, herein incorporate these applications by reference.

As described in greater detail below, an interface can be incorporated into the ATM display of a financial institution. A user can authenticate his/her identity using the ATM authentication system and the user's authentication information and procedures known to the user for interacting with the ATM, such as the user's ATM card and PIN number. The user can then use the ATM interface to select the user's financial institution accounts that he/she wishes to use for the P2P payment.

The ATM interface can also be used to initiate transfers to third parties. In some embodiments the transfer may occur to others that are already within the system. In this way, the system may recognize and pre-establish entities that P2P payments may be sent to and received from. For example, a local cable company may establish themselves on the system, such that users may select the cable company from the ATM interface and make a P2P payment to the cable company. In this way, the user may not need to know any information about the entity at all other than a name or other alias used by the cable company for receiving P2P payments. The user may simply select the entity from the ATM interface and send a payment to that entity. In other embodiments, transfers may be made to other entities, not associated with the system. In this way, a user can create a transfer receiver by entering the receiver's name, alias, phone number, email address, a descriptive name, picture, logo, graphical artwork, etc. commonly referred to as a nickname, for the entity the user wishes to transfer to using the P2P payment system. The user can then create a transfer request by using the ATM interface to select an account associated with the user; the account may be through the financial institution providing the ATM service or through another financial institution. In this way, the user may not be a customer of the financial institution, but still be able to access his/her accounts and the P2P system associated with the ATM. The user may then select a pre-selected entity or create an entity by providing alias information of a receiver, and enter a monetary amount. The financial institution ATM system then accesses the data repository to retrieve account information for the selected entity.

The selected entity may, again, be pre-established entity, such that the account information for the selected entity may be known. Thus, the entity may have registered for the P2P payment program and thereby provide the financial institution an account associated with the entity. If the entity is registered, the banking system sends a transfer notification to the receiver using the alias and/or initiates the funds transfer. If the entity is not registered, then the banking system uses the alias to send the transfer receiver a notification (e.g., a text message, email or the like), the notification telling the person (or entity) that there is a pending transfer that will be processed if the person registers his/her alias with an existing financial institution account and/or opens a new financial institution account. The notification then provides a link to the online banking website, a mobile banking website, or a mobile banking application that allows the person to easily register an existing account or open a new account.

Embodiments of the invention also provide an ATM interface that makes it easy for users to monitor their current, future, pending, and past P2P and/or person-to-merchant (P2M) funds transfers as well as their saved transfer receiver list, alias registrations, incoming transfers, and/or other related information.

Embodiments of the invention relate to systems, methods, and computer program products for receiving payment instructions from a user via the ATM, wherein the payment instructions include information identifying the user, a payment amount, and a payment receiver; determining that the payment receiver is a registered payment receiver, such that account information of the payment receiver is known to a financial institution; communicating a payment notification to the payment receiver based on the payment receiver being the registered payment receiver; and transferring a payment from an account associated with the user to an account associated with the payment receiver.

In some embodiments, the payment receiver may be determined to be an entity associated with the financial institution. In some embodiments, determining the account information of the payment receiver based at least in part on alias information the user provides regarding the payment receiver. The alias information comprises personal identification information about the payment receiver, such that the alias is unique to the payment receiver.

In some embodiments, determining an association between the user and the payment receiver based at least in part on alias information provided by the user. The ATM is provided by a financial institution associated with at least one of the user or payment receiver or both the user and payment receiver.

In some embodiments, the transferring of a payment from an account associated with the user to an account associated with the payment receiver is based at least in part on the payment receiver responding to the payment notification indicating authorization to receive payment. The transferring of a payment from an account associated with the user to an account associated with the payment receiver is provided though an ATM system.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a high level process flow illustrating the ATM P2P payment process, in accordance with embodiments of the invention;

FIG. 2 is a combination flowchart and block diagram of a system and method for making P2P payments in accordance with example embodiment of the invention;

FIG. 3 is a block diagram illustrating the various ways through which a customer may make P2P payments in accordance with various embodiments of the invention;

FIG. 4 provides a block diagram illustrating an ATM P2P payment system and environment in accordance with an embodiment of the invention;

FIG. 5 provides a block diagram illustrating the ATM device of FIG. 4, in accordance with an embodiment of the invention;

FIG. 6 provides a block diagram illustrating the financial institution's ATM system of FIG. 4, in accordance with an embodiment of the invention;

FIG. 7 provides a block diagram illustrating the alias data repository of FIG. 4, in accordance with an embodiment of the invention;

FIGS. 8A-8D provide flow charts illustrating a process for sending P2P payments, in accordance with embodiments of the invention;

FIG. 9 provides a flow chart of the user's decision process for using the P2P payment system, in accordance with embodiments of the invention;

FIG. 10 provides an illustration of an ATM interface, in accordance with example embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution providing the ATM, a customer of the financial institution providing the P2P system, not a customer of the financial institution providing the ATM, not a customer of the financial institution providing the P2P system, or any combination thereof.

Embodiments of the present invention provide a system and method for utilizing an ATM to provide integrated P2P payments. Embodiments of the invention allow users to make payments directly from their accounts, whether their accounts be checking, savings, line of credit, credit card, stock, and/or other accounts, to a payment receiver. In some embodiments, the user and/or payment receiver may be customers of the financial institution providing the ATM or the P2P system. In some embodiments, the user and/or receiver may not be customers of the financial institution providing the ATM or the P2P system. The P2P system further allows transfer of funds from a user to a receiver without sharing any confidential account information and without knowing account information for the intended payment receiver. In some embodiments, the customers may not currently be customers of the financial institution providing the ATM, but may wish to use the P2P system to make payments to other entities. These customers may access their accounts from other financial institutions through the use of the financial institution's ATM. In this way, the customer may access accounts from other financial institutions to make payments through the P2P system. Embodiments of the invention, also allow customers and non-customers to receive payments from others directly into their financial institution accounts without requiring the customer to share account information with the payment sender.

It should be noted that some embodiments of the invention allow a customer to make payments to and/or receive payments from a merchant in the same way that a customer can make payments to and/or receive payments from another person. As such, as used herein, the phrase person-to-person (P2P) is intended to include person-to-merchant (P2M), merchant-to-merchant (M2M), and merchant-to-person (M2P) unless specifically stated otherwise. Moreover, embodiments of the present invention permit a sender to send money from the sender's financial institution account directly to the receiver's financial institution account either by selecting a pre-established receiver from a data repository or providing an alias receiver such that the receiver account information may be determined by the data repository from information inputted by the user. This allows for greater security as no party apart from the sender, the receiver, and the bank is ever a part of the transfer.

It should be appreciated that at least some embodiments of the invention provide a more convenient, user friendly, and secure P2P payment system because it is provided by the user's financial institution, through the financial institution ATM system with which the user is already familiar. In at least some embodiments, the user may not need to share personal or confidential information, such as account information, with people or businesses outside of the user's bank. The user can feel more secure having P2P payment services handled by their financial institution and having the convenience of being able to directly send money from and/or receive money into the user's one or more financial institution accounts via an ATM.

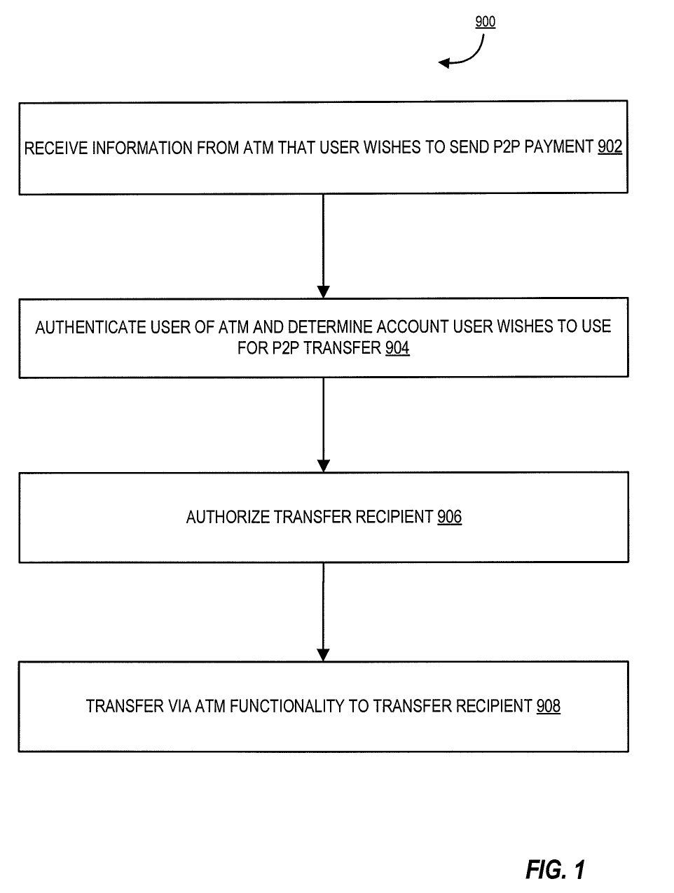

FIG. 1 illustrates a high level process flow of the ATM P2P payment process 900, in accordance with one embodiment of the present invention. First, the system receives information from an ATM that a user wishes to send a P2P payment in block 902. The user may approach the ATM to send a P2P payment. In some embodiments, the user is a customer of the financial institution providing the ATM. In other embodiments, the user is a customer of the financial institution providing the P2P payment system. In yet other embodiments, the user may not be a customer of either the financial institution providing the ATM or the financial institution providing the ATM. In yet other embodiments, the user may be a combination thereof. The user may insert his/her ATM card, alias information, or other identification means. At this point, the system authenticates the user of the ATM and determines the account the user may wish to use for the P2P transfer in block 904. For example, the user may provide an ATM card and a corresponding PIN number associated with that card, to the ATM system. The user may then select the account the user may wish to use for the P2P payment. The account may be an account associated with the financial institution providing the ATM or the account may be with a different financial institution or other entity. In this way, the P2P payment system allows the user to access any of his/her accounts from which to provide P2P payments. The user may select from pre-established P2P payment receivers using an ATM interface or the user may input alias information of a P2P receiver to whom the user wishes to transact. If a pre-established receiver is selected then authentication of the receiver is instantaneous. However, if a user provides an alias for a P2P receiver, the receiver may need to be authorized for the transfer. In block 906 the system authorizes the transfer receiver, whether the receiver is pre-established or an alias is needed. Finally, in block 908, the P2P payment system transfers the payment from the user to the receiver through the user's use of the ATM. In this way, the payment may be transferred directly from the user to the receiver through the financial institution and not a third party. Furthermore, this system allows for secure transfer of payment without leaving the financial institution system security. Finally, this system allows for easy transfer of payments without the user having access to online banking, mobile banking, or even banking during non-business hours. The user is able to send and receive funds any time through the use of an ATM.

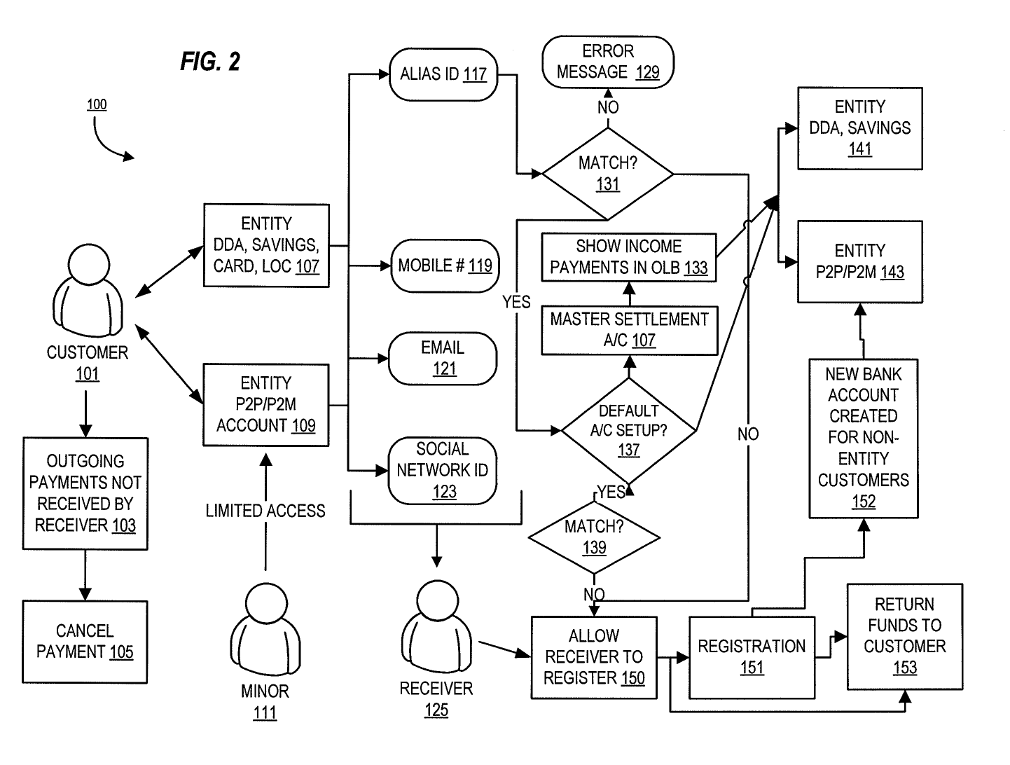

FIG. 2 is a combination block diagram and flowchart providing an overview of a system and method 100 for making P2P payments via ATM functionality, in accordance with one or more embodiments of the invention. A customer 101 or non-customer with an eligible account 107, e.g., checking (demand deposit account or “DDA”), savings, money market, line of credit, credit card, etc., of any financial entity is be able to register and make use of this service. Hereinafter, a customer 101 may include customers of the financial institution providing the P2P payment system or individuals whom are not customers of the financial institution providing the P2P system. During the registration process, the customer 101 is able to set up an alias identifier (ID) 117 (or simply an “alias”) that maps back to the customer's account. The alias 117 may be any unique identifier other than the customer's financial institution account number and may include a name, address, email address, URL address, ATM PIN number, picture, graphical art, trade name, trademark, logo, brand, or any other textual, graphical, or visual indicator. Typically, the alias 117 is an identifier that friends, family, and/or other members of the public uniquely associate with the customer 101. In this way, others may send a payment to the customer 101 through the use of the customer's alias. For example, the alias 117 may be a mobile telephone number 119, an email address 121, a social networking ID 123, an ATM alias, a name, address, URL address, ATM PIN number, picture, graphical art, trade name, trademark, logo, brand, textual indicator, graphical indicator, visual indicator, and/or the like. The embodiments of the invention described herein in the other figures generally permit the customer 101 or non-customer to use either a mobile telephone number 119, ATM alias, or an email address 121 as the account alias, but it will be appreciated that, in view of this disclosure, other embodiments of the invention may allow use of other types of aliases. In another embodiment, an entity may provide information to the P2P system, such that the entities account information may be pre-established within the P2P system. Typically these entities may include, but are not limited to, merchants, retailers, service providers, etc. In this way, the customer 101 may use aliases to send payments to other individuals and use pre-established entities to send payments to merchants and the like.

The information provided by the customer 101 during registration of an alias may be verified to confirm that the customer 101 does have access to the alias. For example verification of an ATM PIN number or the like. In yet another example, the financial institution (or other entity that maintains a database of aliases and associates them with financial institution accounts) may send a communication to the customer 101 using the alias and require the customer 101 confirm access to the alias by responding to the notice in some way. For example, if the alias registered by the customer 101 is a telephone number 119, the financial institution may send a message to the telephone number 119 with a code and then require that the customer 101 enter the code into an ATM interface to confirm that the telephone number is associated with the customer 101. Once the alias information is verified, then the alias is linked to one or more of the customer's financial institution accounts in a data repository maintained by the financial institution or some other entity that provides an alias registry service to the financial institution.

The customer 101 can also use embodiments of the invention to make payments to other entities. Payments to other entities may occur by using an alias of the receiver 125 or the name of the receiver 125 entity, if the receiver 125 has pre-established an account with the P2P payment system. In some embodiments of the invention, the customer 101 is able to set preferences for accounts to be used for outgoing payments, and default account(s) for incoming payments. In some embodiments of the invention, the financial institution places limits (e.g., maximums and/or minimums) on how much money can be sent or received over a specified period of time using P2P payment aliases, and such limits may be based on the sender, the receiver, whether the receiver is a customer of the financial institution or a partner financial institution, account history, credit ratings, customer status, whether the customer has registered the alias, and/or any other relevant information. In some embodiments, the customer 101 can also establish limits on P2P payments. For example, a customer 101 may want to set a maximum of $1000 for P2P payments where an alias is used for the receiver as opposed to an account number.

In some embodiments of the invention, the customer 101 may also have an option of opening a new P2P account 109 with the financial institution that the customer may use exclusively for making and/or receiving P2P payments. This financial entity P2P account 109 may be like any other account hosted at the financial entity and so money may be moved instantly into this account 109 through the regular ATM process for moving money between a customer's accounts. This account 109 may be a type of checking account except that it may come with certain limitations, e.g., no checks, maximum balance limits, number of daily transactions or the like, and may be opened by customers by providing much less information as compared to a regular checking account. The financial entity may, at a minimum, require customers to provide certain information, such as name, address, date of birth, and social security number, in order to comply with Anti-Money Laundering (AML) regulations. Customers 101 of the financial entity may also have an option to set up P2P accounts 109 (i.e., sub-accounts) for minors 111, other dependents, or related entities. Customers 101 are able to access these accounts just like any of their other accounts. In addition, customers 101 are able to set up an ATM access ID for the minor 111 that the minor 111 may use ATM machines but have access only to the specific minor P2P account 109 set up for them. These P2P-specific accounts and sub-accounts are described in more detail in U.S. patent application Ser. No. 12/038,177 filed on Feb. 27, 2008 and entitled “Sub-Account Mechanism,” which application was assigned to, or subject to an obligation to assign to, the same assignee of the present application at the time of filing of the present application and at the time of conception of the inventions described herein.

Referring again to FIG. 2, customers 101 of the financial entity are able to make payments to other people through any of a number of different methods. In one such method the customer 101 may select an entity from a pre-established list of entities. The pre-established entities may include, but are not limited to, merchants, retailers, service providers, etc. The pre-established entities may provide information to the system, such that the system may recognize the accounts associated with the entity. The customer 101 may select the entity, based on the entities name from the ATM interface. The selection of the entity name may be attached to an account for the entity. In this way, the entity may have provided account information and the like to the financial institution, such that the financial institution has access to the account, etc. to use in the P2P payment system. Therefore, the customer may select the entity's name, nickname, or identifier using an ATM interface. Once the customer selected the entity, the customer may direct payment to the entity via the P2P payment system. If the entity pre-established a relationship with the financial institution and the customer provided P2P payment to the entity an error will not occur because the entity has pre-established a relationship with the financial institution and the P2P payment system. Therefore, the entities may not need to provide alias information or confirmation for the alias. In this way, the customer 101 may be able to sent payments to the entity directly without any delay.

In accordance with embodiments of the invention, payments may be made by providing an alias 117. In general, as described in greater detail below, the customer 101 initiates a P2P payment using an alias by communicating an alias for the receiver 125 and an associated payment amount to the financial institution. The financial institution then accesses an alias database, or other type of data repository, to determine if the entered alias 117 has been registered by the alias holder and is, thereby, associated with a particular financial institution account. If the alias 117 does have a match to another customer in 131 or financial institution account of another customer 131, then the payment may be initiated to that person through ATM functionality, as described in greater detail below. If there is no match, then either an error message 129 is generated or, if possible, the alias 117 may be used to contact the intended receiver 125 and allow this person to register the alias 117 and thereby associate the alias with a financial institution account, at block 150. At any time, if outgoing payments or payment notifications are not received by a receiver (as represented by block 103), the payment may be canceled (as represented by block 105).

In some embodiments of the invention, an alias 117 may be associated with multiple financial institution accounts of the alias holder. In some such embodiments, the alias holder may be able to establish a default account when registering the alias 117 or afterwards. Consequently, if a receiver 125 does have a default account for incoming payments in 137, then the funds may be transferred instantly to that account(s). If the receiver 125 has not set up a default account in 137 but the receiver 125 does have multiple accounts associated with the alias 117, then the funds may be moved to a master settlement account 135 and the receiver 125 may see the payment as an incoming payment within online banking 133. The receiver 125 may then be able to use the online banking application to move the funds instantly to any of the receiver's others accounts. In other embodiments, however, each alias 117 is associated only with one financial institution account and, therefore, steps 137 and 135 are not needed and the payment is deposited directly into the one financial institution account associated with the alias 117.

As further illustrated in FIG. 2, the alias 117 may be a telephone number 119 and, as such, payment may be made by the customer 101 providing a phone number 119 (the telephone number 119 being the telephone number of the intended payment receiver 125) along with an associated payment amount onto the ATM interface at the ATM. This operation may perform exactly as described above for the alias 117 if there is a match in 139. If there is no match in 139, then a message may be sent to the receiver (as represented by block 150). If the receiver 125 of the message is an existing financial institution customer (or, in some embodiments, if the receiver 125 is a customer of a partner financial institution), then that person may be allowed to sign into the P2P payment system and register an alias for the P2P system as illustrated by block 151 (thereby associating the phone number with a financial institution account for P2P payment purposes), and then receive funds similar to the process described above for the alias 117. If the receiver 125 is not a financial entity customer with an account eligible for receiving funds, then the receiver 125 may be given the option to sign up (as represented by block 152) for a financial institution account 141 or 143 at the financial institution or return funds to the sender (as represented by block 153).

As further illustrated in FIG. 2, the alias 117 may be an email address 121 and, as such, payment may be made by the customer 101 providing an email address 121 (the email address 121 being an email address of the intended payment receiver 125) along with an associated payment amount. This operation may perform exactly as described above for a mobile number 119 except that the notification message (with the registration or account opening option if appropriate) is sent to the email address 121 provided.

In some embodiments of the invention, payment may be made by providing a social networking ID 123, such as a unique ID associated with the receiver 125 on a particular social networking Internet site. In such a situation, the process operates in the same way as described above for mobile phone number 119 and email address 121 except the social networking platform may be used to notify the receiver based on the social networking ID 123 provided.

In some embodiments, payments may be made by an ATM alias. As such, the receiver 125 may not have access to a mobile device, email address, or social networking ID. In this way, the receiver may set up an alias via an ATM. In this way the receiver may receive payment to an account associated with the ATM alias so that the customer may provide the receiver 125 ATM alias for P2P payment.

In all cases described above, if the receiver 125 is already a customer of the financial institution or a partner financial institution and has already registered the alias 117 provided by the customer 101, a text message, email, online banking notice, mobile banking notice, ATM notification, or other type of message may be sent to receiver 125 based on the alias 117 entered by the customer 101 or irrespective of information entered by sender if there is other contact information found in the receiver's profile, the notification notifying the receiver 125 of the payment. In some embodiments, the receiver 125 may be allowed to reject or re-route the payment. In some embodiments of the invention, the customer 101 is permitted to include a note to the receiver 125 along with the payment, such as a note explaining to the receiver what the purpose of payment. In some embodiments, the receiver 125 is not a customer of the financial institution.

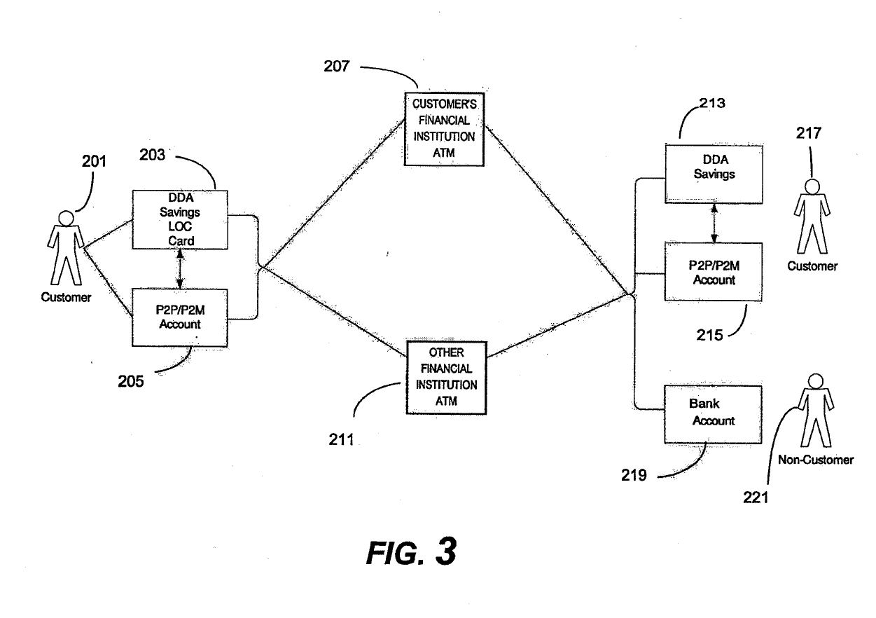

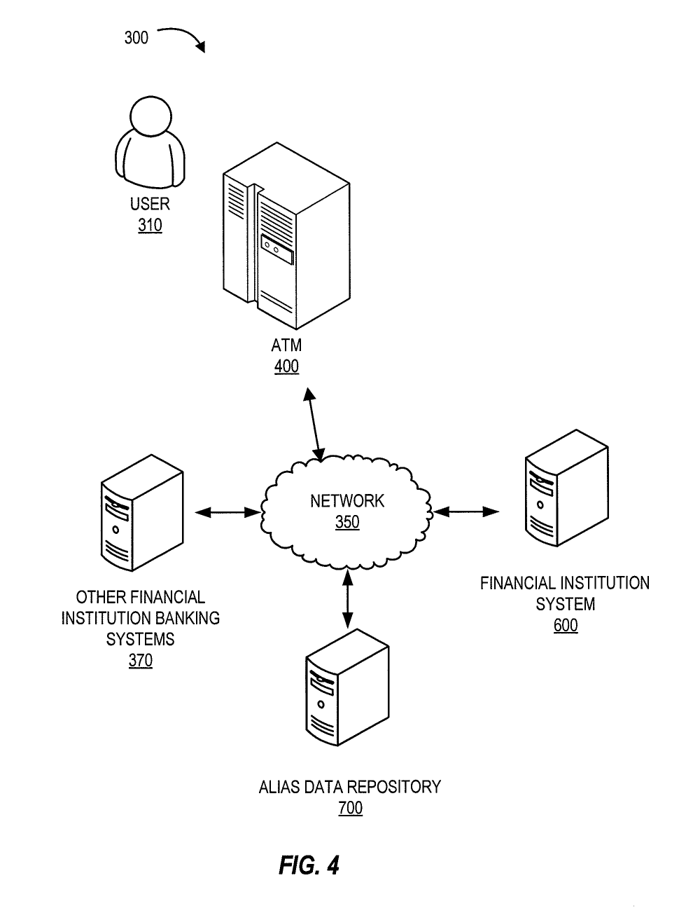

FIG. 3 is a block diagram illustrating the various ways through which a customer may make P2P payments in accordance with various embodiments of the invention. As illustrated, in some embodiments of the invention, a customer 201 who is signed up for the P2P payment service has the option to initiate P2P payments from a DDA, savings, line of credit, and/or credit card account 203 of the financial entity (and/or from a P2P-specific account 205 with the financial entity) through the financial institution's ATM machine 207 or an ATM machine of another financial institution 211 by providing any of the above-described alias information, e.g., phone number, email address, social networking ID, ATM card, PIN number, ATM alias, picture, logo, graphical art, and/or other alias, along with a payment amount. In some embodiments, customers can alternatively or additionally use the financial institution's ATM 207 to initiate a payment using an alias or a pre-selected entity as described in greater detail below with respect to FIGS. 4-10. Whether via a customer's financial institution ATM 207 or another financial institution's ATM 211, a receiver 217 associated with the financial entity may receive funds at the receiver's financial institution account (e.g., DDA, savings, or credit account 213 or P2P-specific account 215). A receiver not associated with the financial entity 221 may receive funds at the receiver's financial institution account 219 at another partner financial institution if the account is registered and associated with the alias and/or the receiver 221 may be prompted to register for the service and/or open an account with the financial institution in order to receive the payment from the sender 201.

It should be appreciated that embodiments of the invention described above permit an entity to send money to another entity even if the sending entity does not know any account information for the receiver entity and only knows an ATM alias, mobile telephone number, email address of the receiver entity or the receiver entity is pre-established to receive payments via the P2P payment system. This can also result in better protection of personal account information. It should also be appreciated that some embodiments of the invention create a viral registration and/or account opening system that allows for customers of a financial institution to send payments to anyone outside the financial entity using an alias. In such embodiments, the non-customers are contacted using the alias and they are allowed to quickly open and/or register an account with the financial institution in order to receive the funds from the sender.

FIG. 4 provides a block diagram illustrating an ATM P2P payment system and environment 300, in accordance with an embodiment of the invention. As illustrated in FIG. 4, the P2P payment environment 300 includes a user 310 that wants to send funds to a receiver. A user 310 of the system may be a person, but may also be a business (e.g., a merchant, retailer, manufacturer, or the like) or any other entity capable of sending or receiving money.

The environment 300 also includes one or more ATM machines 400. Each ATM 400 may be a device that employs a processor and memory and can perform computing functions, such as accessing, retrieving, and sending funds via an ATM system.

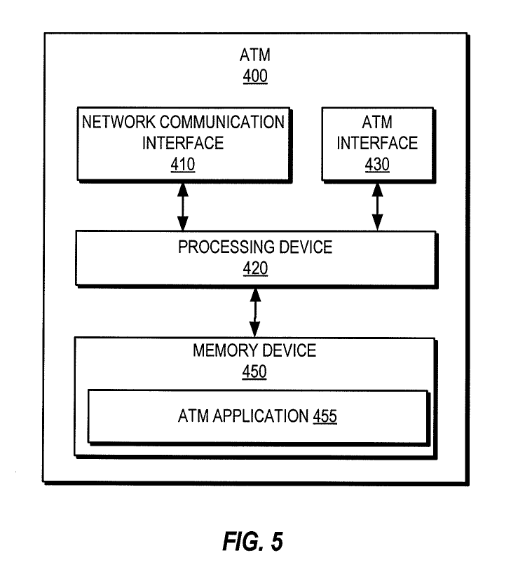

The ATM 400 is configured to communicate over a network 350 with a financial institution's ATM system 600 and, in some cases, one or more other financial institution banking systems 370. The ATM 400, the financial institution's ATM system 600, an alias data repository 700, and any other participating financial institution's banking systems 370 are each described in greater detail below with reference to FIGS. 5-7.

The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet.

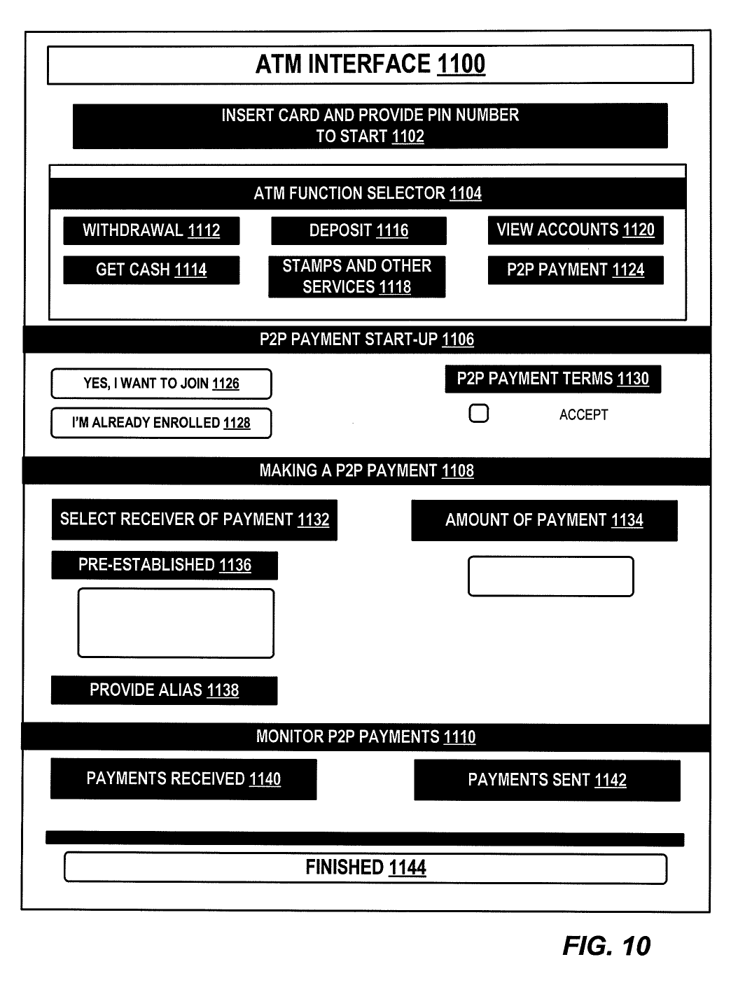

In general, an ATM 400 is configured to connect with the network 350 to log the user 310 into a financial institution system 600. The financial institution system 600 involves authentication of the user 310 in order to access the user's account on the financial institution system 600. For example, the financial institution system 600 is a system where a user 310 logs into his/her account, using either an ATM card at an ATM 400 along with a PIN number, such that the user 310 or other entity can access data that is associated with the user 310. For example, in one embodiment of the invention, the financial institution system 600 provides an ATM 400 maintained by a financial institution. In such an embodiment, the user 310 can use the ATM 400 to log into the financial institution system 600 to access the user's accounts. Logging into the financial institution system 600 generally requires that the user 310 authenticate his/her identity using an ATM card, debit card, a PIN number, user name, a passcode, a cookie, a biometric identifier, a private key, a token, and/or another authentication mechanism that is provided by the user 310 to the financial institution system 600 via the ATM 400. The ATM may provide the user 310 with access to the P2P system via an interface, such as that described below with respect to FIG. 10. In this way, the ATM 400 receives the input from the user 310 to initiate and finalize a P2P payment.

The financial institution's ATM system 600 is in network communication with other devices, such as other financial institution banking systems 370, an alias data repository 700, and an ATM 600.

In some embodiments of the invention, the alias data repository 700 is configured to be controlled and managed by one or more third-party data providers (not shown in FIG. 3) over the network 350. In other embodiments, the alias data repository 700 is configured to be controlled and managed over the network 350 by the same entity that maintains the other financial institution banking systems 370. In other embodiments, the alias data repository 700 is configured to be controlled and managed over the network 350 by the financial institution implementing the ATM P2P payment system of the present invention. In still other embodiments, the alias data repository 700 is a part of the financial institution system 600.

Referring now to FIG. 5, the ATM 400 in which the user 310 uses to initiate the P2P system includes various features, such as a network communication interface 410, a processing device 420, an ATM interface 430, and a memory device 450. The network communication interface 410 includes a device that allows the ATM 400 to communicate over the network 350 (shown in FIG. 4). In addition, an ATM application 455 is stored in the memory device 450. The ATM application 455 provides for the user to establish network communication with the financial institution system 600 (shown in FIG. 4) for the purpose of initiating the ATM P2P payment, in accordance with embodiments of the present invention.

As used herein, an “ATM interface” 430 generally includes a plurality of interface devices that allow a customer to input commands and data to direct the processing device to execute instructions. As such, the ATM interface 430 employs certain input and output devices to input data received from the user 310 or output data to the user 310. These input and output devices may include a display, mouse, keyboard, button, touchpad, touch screen, microphone, speaker, LED, light, joystick, switch, buzzer, bell, and/or other customer input/output device for communicating with one or more customers using an ATM machine.

The ATM 400 provides means for the user 310 to authenticate himself/herself by logging into the ATM P2P system. Furthermore, the ATM 400 provides the user 310 access to the financial institution system 600, such that the user 310 may send funds to a receiver through the financial institution system 600. The ATM 400 provides the user 310 all ATM functionality, including allowing the user 310 to deposit, withdrawal, and receive funds. The ATM 400 further provides the ATM application 455 that allows a user to send funds to a receiver directly, using the ATM functionality. In this way, the user 310 may select a pre-established receiver or provide alias information for a receiver and send funds to the receiver from an account associated with the financial institution system 600. In this way, the funds may be sent securely from an ATM 400 to the financial institution system 600, wherein the financial institution system 600 sends the funds to the receiver's financial institution. Thus, the sending and receiving of funds never exits the financial institution's networks to an outside network.

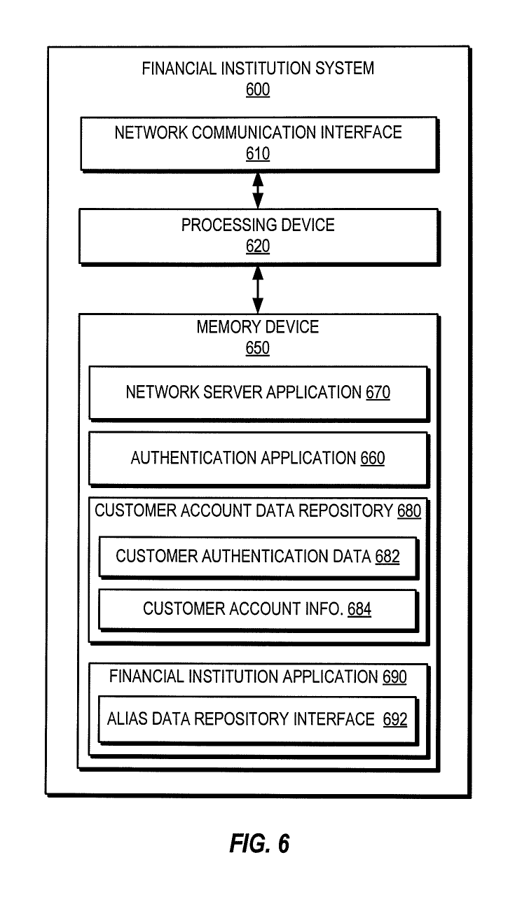

FIG. 6 provides a block diagram illustrating the financial institution system 600 in greater detail, in accordance with embodiments of the invention. As illustrated in FIG. 6, in one embodiment of the invention, the financial institution system 600 includes a processing device 620 operatively coupled to a network communication interface 610 and a memory device 650. In certain embodiments, the financial institution system 600 is operated by a first entity, such as a financial institution, while in other embodiments, the financial institution system 600 is operated by an entity other than a financial institution.

As used herein, a “processing device,” such as the processing device 420 or the processing device 620, generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 420 or 620 may further include functionality to operate one or more software programs based on computer-executable program code thereof, which may be stored in a memory. As the phrase is used herein, a processing device 420 or 620 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device” 450 or 550 generally refers to a device or combination of devices that store one or more forms of computer-readable media and/or computer-executable program code/instructions. Computer-readable media is defined in greater detail below. For example, in one embodiment, the memory device 450 or 550 includes any computer memory that provides an actual or virtual space to temporarily or permanently store data and/or commands provided to the processing device 420 or 520 when it carries out its functions described herein.

It should be understood that the memory device 650 may include one or more databases or other data structures/repositories. The memory device 650 also includes computer-executable program code that instructs the processing device 620 to operate the network communication interface 610 to perform certain communication functions of the financial institution system 600 described herein. For example, in one embodiment of the financial institution system 600, the memory device 650 includes, but is not limited to, a network server application 670, an authentication application 660, a customer account data repository 680, which includes customer authentication data 680 and customer account information 684, and an financial institution application 690, which includes an alias data repository interface 692 and other computer-executable instructions or other data. The computer-executable program code of the network server application 670, the authentication application 660, or the financial institution application 690 may instruct the processing device 620 to perform certain logic, data-processing, and data-storing functions of the online system 600 described herein, as well as communication functions of the online banking system 600.

In one embodiment, the customer account data repository 680 includes customer authentication data 682 and customer account information 684. The network server application 670, the authentication application 660, and the financial institution application 690 are configured to implement customer account information 684, the customer authentication data 682, and the alias data repository interface 692 when authenticating the customer 101 to the financial institution system 600.

As used herein, a “communication interface” generally includes a modem, server, transceiver, and/or other device for communicating with other devices on a network, and/or a ATM interface for communicating with one or more customers. Referring again to FIG. 6, the network communication interface 610 is a communication interface having one or more communication devices configured to communicate with one or more other devices on the network 350, such as the ATM 400, the financial institution system 600, the other financial institution banking systems 370, and the alias data repository 700. The processing device 620 is configured to use the network communication interface 610 to transmit and/or receive data and/or commands to and/or from the other devices connected to the network 350.

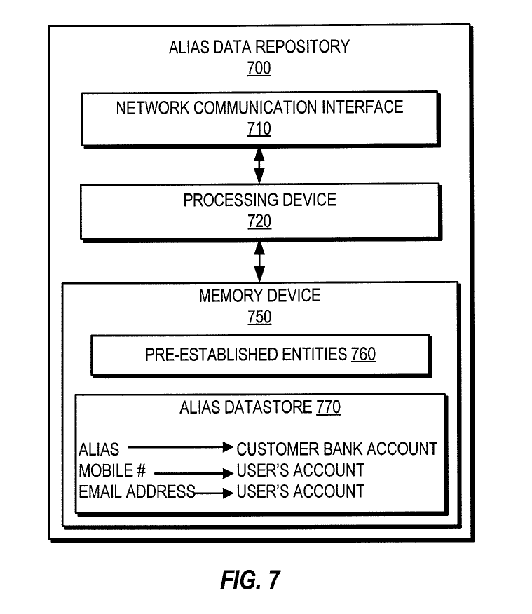

FIG. 7 provides a block diagram illustrating an alias data repository 700, in accordance with an embodiment of the invention. In one embodiment of the invention, the alias data repository 700 is operated by a second entity that is a different or separate entity from the first entity (e.g., the financial institution) that, in one embodiment of the invention, implements the financial institution system 600. In one embodiment, the alias data repository 700 could be part of the financial institution system 600. In another embodiment, the alias data repository 700 is a distinct entity from the financial institution system 600. As illustrated in FIG. 7, the alias data repository 700 generally includes, but is not limited to, a network communication interface 710, a processing device 720, and a memory device 750. The processing device 720 is operatively coupled to the network communication interface 710 and the memory device 750. In one embodiment of the alias data repository 700, the memory device 750 stores, but is not limited to, pre-established entities 760 and an alias data store 770. The pre-established entities are stored in the memory device 750 and are subsequently displayed to the user, on the ATM 400 via an ATM interface. The pre-established entities 760 may include, but are not limited to merchants, retailers, manufacturers, service providers, or other entities that may regularly receive P2P payments from a customer. For example, a local electric company may receive monthly payments from its customers. Therefore, the local electric company could pre-establish itself on the P2P system, such that the customer may provide payment for his/her electric service via the ATM P2P payment system.

The memory device 750 also provides an alias data store 770 which stores data including, but not limited to, an alias for the customer or a receiver, such that the system may recognize the account associated with the alias and direct payment thereto. The alias may be any number of unique identifiers including a telephone number, PIN number, debit card, ATM card, other ATM alias, or email address. In one embodiment of the invention, the pre-established entities 760 and the alias data store 770 may associate with applications having computer-executable program code that instructs the processing device 720 to operate the network communication interface 710 to perform certain communication functions involving the alias data store 770 described herein. In one embodiment, the computer-executable program code of an application associated with the alias data store 770 may also instruct the processing device 720 to perform certain logic, data processing, and data storing functions of the application associated with the alias data store 770 described herein. An alias, as defined in this invention, is not limited to just a debit card or ATM card (magnetic strip recognition), a PIN number, telephone number, or an email address.

The network communication interface 710 is a communication interface having one or more communication devices configured to communicate with one or more other devices on the network 350. The processing device 720 is configured to use the network communication interface 710 to receive information from and/or provide information and commands to an ATM 400, other financial institution banking systems 370, the alias data repository 700, the financial institution system 600 and/or other devices via the network 350. In some embodiments, the processing device 720 also uses the network communication interface 710 to access other devices on the network 350, such as one or more web servers of one or more third-party data providers. In some embodiments, one or more of the devices described herein may be operated by a second entity so that the third-party controls the various functions involving the alias data repository 700. For example, in one embodiment of the invention, although the financial institution system 600 is operated by a first entity (e.g., a financial institution), a second entity operates the alias data repository 700 that stores the alias details for the customer's financial institution accounts and other information about customers.

As described above, the processing device 720 is configured to use the network communication interface 710 to gather data from the various data sources. The processing device 720 stores the data that it receives in the memory device 750. In this regard, in one embodiment of the invention, the memory device 750 includes datastores that include, for example: (1) aliases for customer financial institution account numbers and routing information, (2) information regarding pre-established receiver entities; (3) information about sending and receiving users' numbers, email addresses, or other contact information, which may have been received from the financial institution system 600; and/or (4) customer credentials (e.g., a customer ID) received from the customer when the customer enrolled in the account or from the ATM 400.

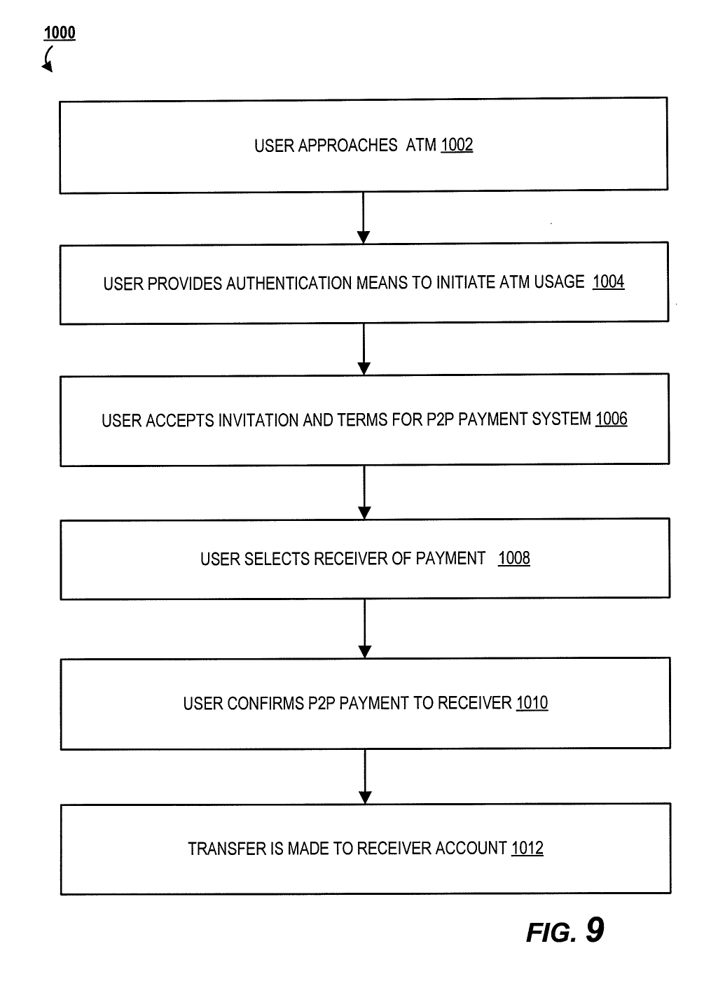

Referring next to FIG. 9, providing a flow chart of the user's decision process for using the P2P payment system. First, the user may approach an ATM machine in block 1002. In some embodiments the ATM 400 may be associated with a financial institution with whom the user has an account. In other embodiments, the ATM 400 may not be associated with a financial institution with whom the user has an account, however, the ATM 400 may provide for P2P payments. Once the user approaches the ATM 400, the user may provide the ATM with authentication means in block 1004. The authentication means may be a debit or ATM card and an associated PIN number. Once the user provides this information to the ATM 400, the user may receive full functionality of the ATM 400. The user may wish to use the ATM for typical ATM functions, such as accessing accounts, depositing, making withdrawals, etc. The user may also accept an invitation to provide or receive a P2P payment in block 1006. The user may then select the receiver of the P2P payment in block 1008. The receiver may be a pre-established receiver or the user may have to provide alias information of the receiver, such that the system may determine the receiver. The user may then input the receiver and amount of payment to the receiver through a display on the ATM 400 providing an ATM interface, such as that described in further detail below with respect to FIG. 10. Once the user inputs the receiver and the amount, the user may confirm the payment to the receiver in block 1010. In block 1012, once the user has confirmed payment, the system transfers the funds directly to the account of the receiver through the use of the financial institution system 600.

FIG. 10 provides an ATM interface 1100 that allows the user to make the decisions described above in FIG. 9. In one embodiment shown in FIG. 10, the financial institution system 600 indicates to the user that he or she is invited to participate in the P2P transfer service via an interface on the ATM 400. The information provided in the ATM interface 1100 is configured to inform the user that he/she can send money to a receiver using the P2P system. The user may first provide an ATM card, debit card, a PIN number, or other authorization information in section 1102 to begin the P2P payment process. Once the system has authorized the user, the user may select the ATM functions that he/she wishes to perform in section 1104. The ATM functions may be standard ATM functions such as withdrawals 1112, quick cash 1114, depositing money 1116, viewing accounts 1120, or other services of the ATM, such as stamps 1118. The ATM 400 may also provide the user the option of sending or receiving a P2P payment 1124.

If the user selects the P2P payment option, he/she is directed to the P2P payment start-up section 1106. At the P2P payment start-up section 1106 the user may join the program if he/she hasn't done so already, by selecting the “yes, I want to join” button 1126. If the user has already joined then he/she may select the “I′m already enrolled” button 1128. The user may then accept the terms of the P2P payment by checking the accept box in section 1130.

The user may then proceed to making a P2P payment in section 1108. In the making a P2P payment section 1108 the user is prompted to select a receiver of the payment in section 1132. The receiver may be from a pre-established group 1136 or the user may have to provide alias information regarding the receiver 1138. The pre-established group 1136 may be companies, merchants, retailers, manufactures, service providers, and the like that have previously enrolled in the P2P program. In some embodiments, the pre-established group 1136 may be commercial partners with the financial institution providing the P2P payment system. In this way, the financial institution system 600 or the alias data repository 700 may already have account information for these pre-established entities. Therefore, the user may select the name or the nickname associated with the pre-established entity and direct a P2P payment to that entity. The user may also provide an alias for an individual or entity that the user may wish to make a payment to if the individual is not pre-established in section 1138. The alias may be any number of identifiers of the receiver, such as, but not limited to telephone numbers, email addresses, addresses, unique identifiers, etc. that the alias data repository 700 may recognize such that the alias may be matched to a receiver account. The system then confirms the payment with the receiver and the account associated with the receiver's alias. In this way, the user does not have to provide any account, routing, or financial data of the receiver to provide a payment to the receiver. Once the user has determined the receiver of the payment, the user may provide the amount of the payment to send in section 1134.

If the user has completed the payment or wishes to monitor payments (sent or received) via the P2P program, the user may select the monitor P2P payments section 1110. In this section, the user may monitor payments received 1140 and payments sent 1142 to ensure that the payments have occurred and directed to the appropriate accounts.

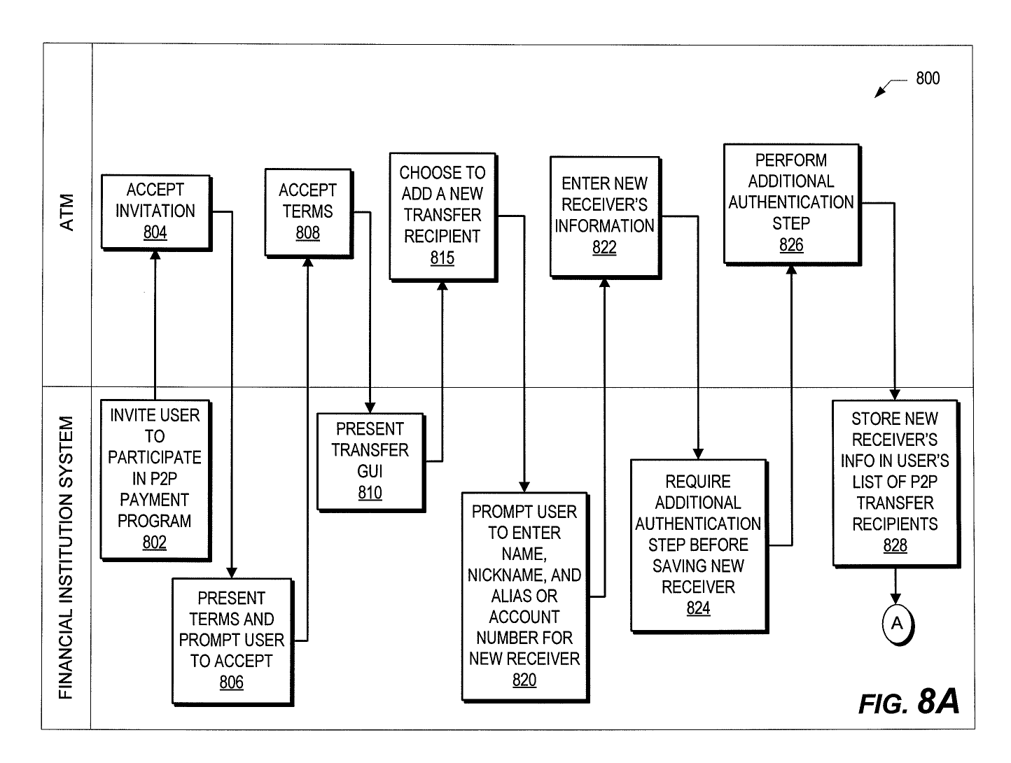

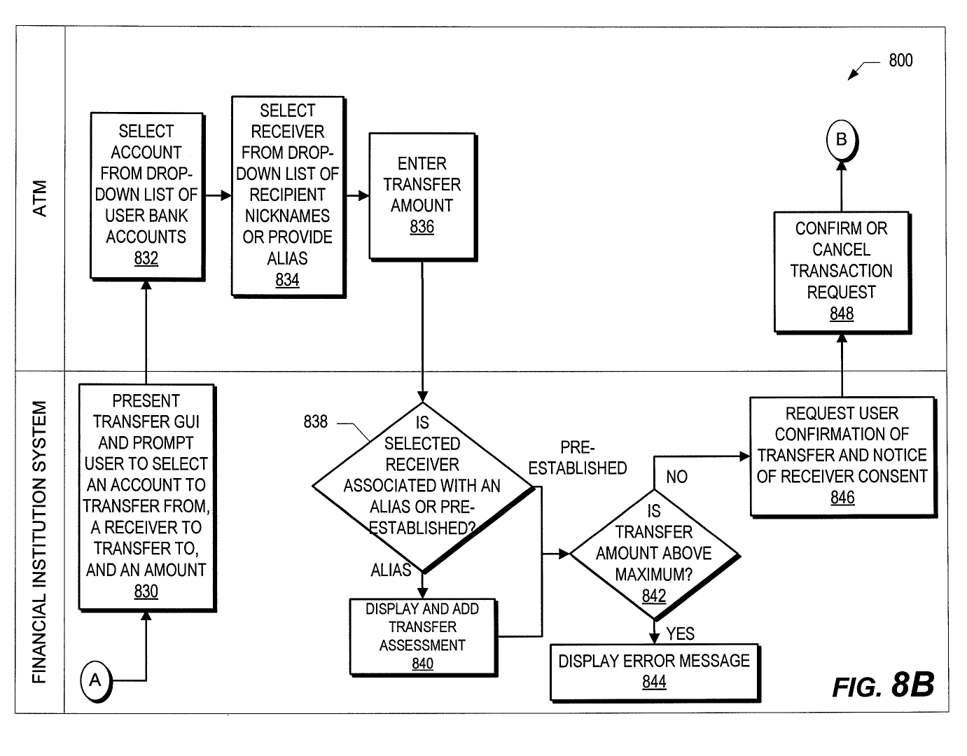

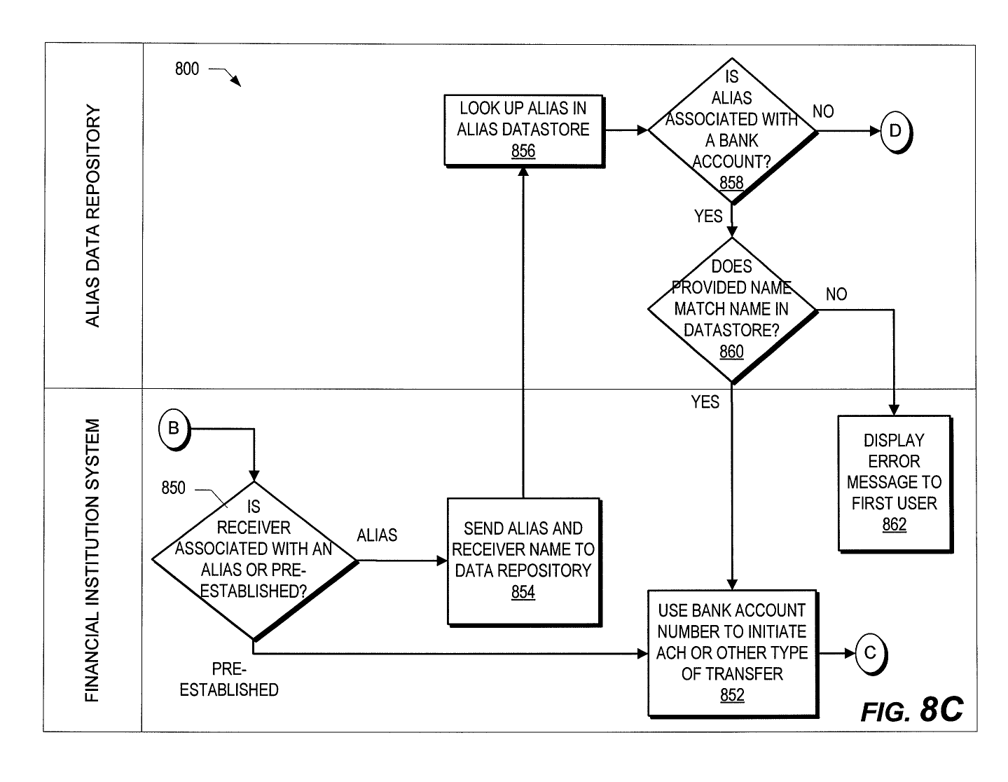

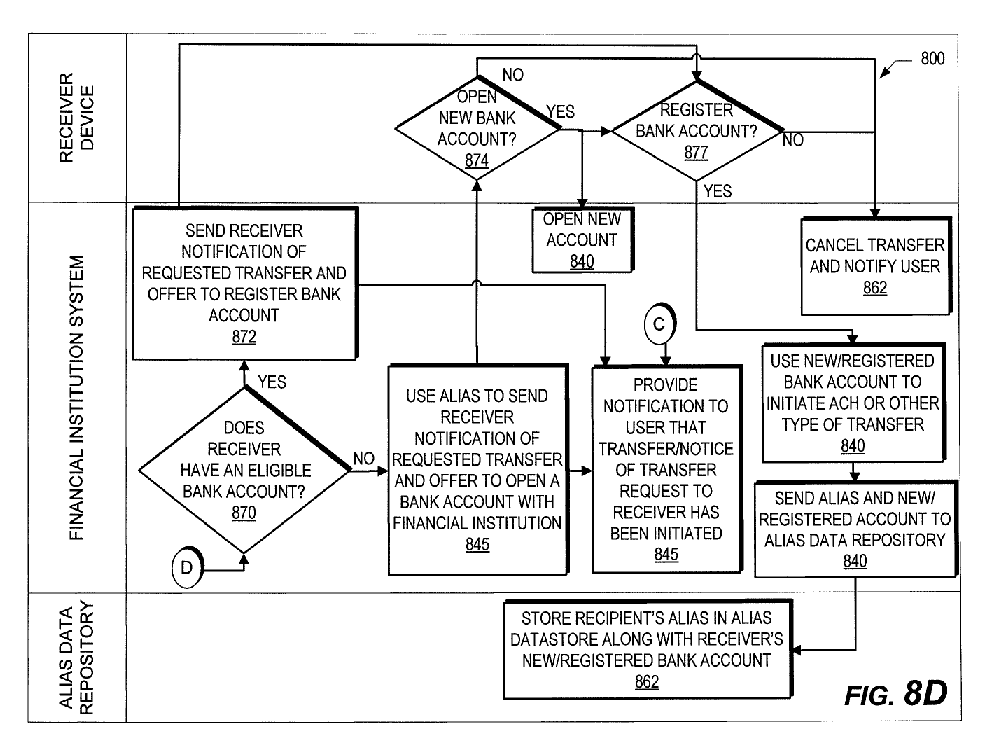

FIGS. 8A-8D provide flow charts illustrating a process 800 for sending P2P payments using an alias or pre-established entity selection, in accordance with an embodiment of the invention. FIGS. 8A-8D illustrates the flow chart in terms of “swim lanes” associated with entities which may perform the operations in each respective swim lane. The entities illustrated in the exemplary Figures are a financial institution system, an ATM, an alias data repository, and a receiver entity. However, it should be noted that other entities could also be involved and some embodiments of the invention may not be limited to the four entities illustrated in FIGS. 8A-8D. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process begins at block 802 of FIG. 8A where a financial institution system 600 invites a user to participate in a P2P payment program. The invitation occurs when a user is accessing an ATM. An ATM interface may provide the user once the user has logged into an ATM. Accessing the ATM may be done by using traditional ATM authentication means, such as a debit card, ATM card, or PIN number. Once the user is successfully authenticated an ATM interface, as illustrated in FIG. 10, will provide the user with a step-by-step interface for completing a P2P payment via an ATM.

The process then moves to block 804 where the user 310 using the ATM 400 accepts the invitation from the ATM interface by activating the button that reads “Yes, I Want to Join.”

The process then moves to block 806 of FIG. 8A where the financial institution system 600 presents to the user the terms of the P2P transfer feature that will govern the transfer of funds. The terms allow the financial institution system 600 to inform the user of the merits of using the P2P transfer service via an ATM. These merits include, but are not limited to, making person-to-person transfers of money by using the ATM functionality, without the need of providing an account number or other personal identifiers. Additionally, information is provided to the user that a fee may be associated with transferring funds to a person not on the pre-established list, by using an alias or the like. The financial institution system 600 also informs the first user that the amount of any fee is disclosed prior to making the P2P transfer via alias. The financial institution system 600 also informs the user that he/she can read more details about this fee in the service agreement that is linked into the P2P payment terms of the ATM interface 1100. In some embodiments, a fee may not be associated with using an alias. In some embodiments a fee may not be associated with using a pre-established receiver.

The financial institution system 600 also informs the user that there may be dollar amounts and other limits that apply for these P2P transfers. The financial institution system 600 may informs the user that the user may find in the P2P payment terms an applicable daily cut off times and delivery times for making these P2P transfers. FIG. 10 also illustrates a confirmation or acceptance check box which the user may activate if the user confirms that he/she has (a) has read and agrees to the terms of the service agreement. The first user accepts the terms of the P2P service by activating the checkbox that confirms that the first user meets the requirement discussed in the terms, and then activating the “accept” checkbox to indicate the first user's willingness to proceed with setting up the P2P transfer via the ATM 400.

The process then moves to block 810 of FIG. 8A where the financial institution system 600 presents a transfer GUI so that the user can input all the information required to make the transfer. The process then moves to block 815. The user chooses to add a new transfer receiver to their P2P alias. Adding a new transfer receiver may be accomplished by selecting the receiver of the payment in section 1132 of the ATM interface 1100. The receiver may be either a pre-established entity or an alias. By providing an alias, the user indicates that the user wishes to add a new transfer receiver. By doing so, the first user also indicates that the intended receiver is not listed on the drop-down list of pre-established receivers.

The process then moves to block 820 where the user is prompted to enter new receiver information including, but not necessarily limited to, the name of the receiver, the nickname of the receiver and the alias or account number for the new receiver. FIG. 10 provides a link within the ATM interface to provide this information, the provide alias section 1138. The financial institution system 600 may prompt the user to enter the intended receiver's first name and last name. In one embodiment, the page displays an indicator, such as an asterisk or the like, that indicates that information fields are required to be completed by the user, as opposed to optional fields which are not designated with the indicator. Additionally, the user may be prompted to optionally enter the intended receiver's nickname in a textbox.

The process then moves to block 822 at which point the user enters the new receiver's information in the appropriate fields of an interface. The user may enter the nickname of the new receiver in the designated field. This nickname can be any name that the first user chooses to associate with the intended receiver for the purpose of subsequently identifying the receiver based on alias information such as telephone numbers, email addresses, ATM PIN numbers, or other unique numbers that may identify the user.

The process then moves to block 824 in which additional authentication may be required prior to adding the new receiver to the database. The additional authentication is a safety measure to ensure the payment of funds is being directed correctly. The additional authentication may require contacting the receiver and having the receiver verify information such as a password, etc. The process then proceeds to block 826, in which the additional authentication step is completed. Once the receiver inputs the received code to confirm that the code is correct, the new receiver is activatable so that the user can now provide P2P payments to that receiver. The financial institution system 600 can then store the intended receiver's information or direct it to the alias data repository 700 for storage. The process then moves to block 828 and the new intended receiver's information is stored in a list of P2P payment receivers.

Turning the reader's attention to FIG. 8B, the process then moves to block 830 where the financial institution system 600 presents a transfer GUI so that the user can input all the information required to make the transfer. At block 832 the user may select the account from which he/she would like to transfer funds from. These accounts may be, but are not limited to, checking accounts, savings accounts, mutual funds, lines of credit, and/or the like. In some embodiments, the account may be an account associated with the financial institution providing the ATM. In other embodiments, the account may be associated with a financial account or other entity, not associated with the financial institution providing the ATM.

At block 834 of FIG. 8B, a transfer receiver is selected from either drop-down list of receiver nicknames or user provided alias information for the receiver the user wishes to transfer funds. In one embodiment, the financial institution system 600, via the ATM interface 1100 presents a drop-down list of pre-established receivers which lists several frequency options of users of the P2P system. In other embodiments, the user financial institution system 600 may provide the user with an ATM interface 1100 to provide alias information for the receiver the user wishes to transfer funds to.

The process then moves to block 836 of FIG. 8B, at which the transfer amount is entered. As indicated in FIG. 10, the user inputs into the amount textbox the amount of money that the user intends to transfer to the intended receiver. In one embodiment, the first user selects an appropriate frequency option from a drop-down list which lists several frequency options, such as, a one-time, immediate transfer, a one-time future transfer, a periodic transfer over a preconfigured cycle or the like.

The process then moves to block 838 of FIG. 8B. Here, the financial institution system 600 determines whether the receiver selected by the user in block 834 is associated with an alias or is a pre-established entity for the P2P process. If the selected receiver is associated with an alias, then the process moves to block 840 where the financial institution system 600 displays a pre-confirmation page where the transfer fee is added to the amount entered in block 836. If the selected receiver is a pre-established entity and, thus, no fee is required or once the fee has been added to the alias-type transfer, the process moves to block 842.

In block 842, the financial institution system 600 determines whether the total transfer amount exceeds the maximum permitted in the transaction. In one embodiment, the maximum amount that can be transferred using the P2P service is dependent on several factors including, but not limited to, the user's identity, the receiver's identity, the length and nature of the user's relationship with the financial institution, the length and nature of the receiver's relationship with the financial institution, the amount of funds that the user has deposited at the financial institution, the user's financial institution status, etc. In one embodiment, the maximum amount that can be transferred using the P2P transfer method is dynamically determined at the time the transfer is set-up by a supporting application that works in conjunction with or is embedded within the financial institution system 600.

If the transfer amount is above the maximum permitted in this particular transaction, the process moves to block 844 of FIG. 8B and the financial institution system 600 displays an error message to the user.

If the transfer amount is below or equal to the maximum permitted in this particular transaction, the process moves to block 846 of FIG. 8B where the financial institution system 600 requests the user's confirmation of the transfer and notice of receiver consent. The financial institution system 600 may display a question asking whether the user wants to make the transfer. Furthermore, the financial institution system 600 also displays the account from which funds will be transferred if the user chooses to proceed with the transfer, the receiver's nickname of the receiver or the alias type, the amount of money that will be transferred if the user chooses to proceed with the transfer, the transfer fee that will be incurred by the user if the first user chooses to proceed with the transfer, the total amount of the transaction if the user chooses to proceed with the transfer, the account from which the user executes the transfer if the user chooses to proceed with the transfer, etc. In another embodiment of the invention, an entity or person other than the user will incur the transfer fee. In one embodiment, only a few characters of the identifying information for the sending account are displayed.

The process then moves to block 848 where the user can confirm the user's intention to make a transfer. Alternatively, the user can cancel the transaction. Once the user confirms the transfer, the financial institution system 600 may displays a message, via the ATM interface 1100 to the user that the transfer request has been received by the financial institution system 600 and that the receiver has been notified. The ATM interface 1100 may further provide confirmation as to the account from which money will be transferred along with the new account balance after the deducting the total amount for the transfer. Further, the ATM interface 1100 may also displays the nickname of the receiver to whom the money will be transferred and/or the associated alias type. The ATM interface 1100 may also displays the amount transferred, the fee associated with the transaction, the transfer date, and a unique confirmation number.

Referring to FIG. 8C, the process then moves to block 850 where the online banking system 600 determines if the receiver is associated with an alias or pre-established list of entities. If the receiver is associated with a pre-established entity, the process moves to block 852 where the financial institution system 600 uses the financial institution account number of the pre-established entity to initiate an Automated Clearing House (ACH) transfer or other type of transfer. In this way, the receiver is a part of the pre-established entities and as such the receiver may receive the payment directly without any additional conformation or account information.

If the receiver is associated with an alias, then, the process moves to block 854 where the financial institution system 600 sends the alias and the receiver's name to an alias data repository 700. The process then moves to block 856 where the alias data repository 700 looks up the alias in an alias datastore. Then the process moves to block 858, where the alias data repository 700 determines whether the alias is associated with a financial institution account. If the alias is associated with a financial institution account, then the process moves to block 860 where, if the alias data repository 700 determines that the provided name matches the name in the datastore, then the process moves to block 852 of FIG. 8C where the financial institution system 600 uses the financial institution account number to initiate an ACH transfer or other type of transfer. If in block 860 of FIG. 8C, the provided name does not match a name in datastore, then the financial institution system 600 displays an error message to the user that the transfer cannot be completed.

If in block 858 of FIG. 8C, the alias data repository 700 determines that the alias is not associated with a financial institution account, then the process moves to block 870 of FIG. 8D where the financial institution system 600 determines if the receiver has an eligible financial institution account. If the receiver does not have an eligible financial institution account, then at block 845, the financial institution system 600 uses an alias to send the receiver notification of requested transfer from the user and an offer to open a financial institution account with the financial institution that manages the financial institution system 600. Then the process moves to block 847 where the financial institution system 600 provides notification to the user that transfer or notice of transfer request to the receiver has been initiated.

The process then moves on from block 845 to block 874 of FIG. 8D, where the receiver associated with an alias may decides if they desire to open a financial institution account at the financial institution associated with the financial institution system 600. If the receiver does not desire to open an account, then at block 862, the financial institution system 600 cancels the transfer and notifies the user.

If in block 874 of FIG. 8D, the receiver associated with an alias decides to open a new financial institution account, the financial institution system 600, in block 840, opens a new account for the receiver. Subsequently, the receiver must determine in block 877 whether he/she registers the new financial institution account for the P2P service via the alias.

As shown in FIG. 8D, if receiver associated with an alias in block 877 does not register the new financial institution account opened in block 874, then, at block 862, the financial institution system 600 cancels the transfer and notifies the user.

As shown in FIG. 8D, if the receiver registers the new financial institution account in block 877 for P2P transfers via alias, then the financial institution system 600, in block 840, uses the new registered financial institution account to initiate an ACH transfer or other type of transfer. The process then proceeds to block 841 where the financial institution system 600 sends the alias and the new registered account information to the alias data repository 700. The process then proceeds to block 862 of FIG. 8D where the alias data repository stores receiver's alias in alias datastore along with receiver's new registered financial institution account.

If the receiver has an eligible financial institution account as determined by the financial institution system 600 in block 870, then the process moves to block 872 in FIG. 8D where the financial institution system 600 uses an contact information of the receiver to send the receiver notification of requested transfer and offers to register the receiver's financial institution account and alias. As shown in FIG. 8D, then the process moves to block 847 where the financial institution system 600 provides notification to the user that transfer or notice of transfer request to the receiver has been initiated. As shown in FIG. 8D, the process then moves on to block 874 of FIG. 8D, where if the receiver decides not to register a financial institution account for P2P transfers via alias. In some embodiments, the financial institution system 600 cancels the transfer and notifies the user. In other embodiments, the financial institution system 600 allows for the transfer of funds to another financial institution account of the receiver.

As shown in FIG. 8D, if the receiver registers the eligible financial institution account in block 877, then, at block 840, the financial institution system 600 uses the new registered financial institution account to initiate ACH or other type of transfer. The process then proceeds to block 841 where the financial institution system 600 sends alias and the new registered account information to the alias data repository. The process then proceeds to block 862 of FIG. 8D where the alias data repository stores receiver's alias in alias datastore along with receiver's new registered financial institution account.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing payment via an ATM, the method comprising:
receiving payment instructions from a user via the ATM, wherein the payment instructions include information identifying the user, a payment amount, and a payment receiver;
determining, via a computing device, that the payment receiver is a registered payment receiver, such that account information of the payment receiver is known to a financial institution;
communicating a payment notification to the payment receiver based on the payment receiver being the registered payment receiver; and
transferring a payment from an account associated with the user to an account associated with the payment receiver.

2. The method of claim 1 further comprising determining that the payment receiver is an entity associated with the financial institution.

3. The method of claim 1 further comprising determining the account information of the payment receiver based at least in part on alias information the user provides regarding the payment receiver.

4. The method of claim 3, wherein alias information comprises personal identification information about the payment receiver, such that the alias is unique to the payment receiver.

5. The method of claim 1 further comprising determining an association between the user and the payment receiver based at least in part on alias information provided by the user.

6. The method of claim 1, wherein the ATM is provided by a financial institution associated with at least one of the user or payment receiver or both the user and payment receiver.

7. The method of claim 1 further comprising the transferring of a payment from an account associated with the user to an account associated with the payment receiver is based at least in part on the payment receiver responding to the payment notification indicating authorization to receive payment.

8. The method of claim 1, wherein the transferring of a payment from an account associated with the user to an account associated with the payment receiver is provided though an ATM system.

9. A computer program product for providing payments via an ATM, the computer program product comprising a non-transitory computer-readable medium having computer-executable instructions for performing:
receiving payment instructions from a user via the ATM, wherein the payment instructions include information identifying the user, a payment amount, and a payment receiver;
determining that the payment receiver is a registered payment receiver, such that account information of the payment receiver is known to a financial institution;
communicating a payment notification to the payment receiver based on the payment receiver being the registered payment receiver; and
transferring a payment from an account associated with the user to an account associated with the payment receiver.

10. The computer program products of claim 9 further comprising computer-executable instructions for determining that the payment receiver is an entity associated with the financial institution.

11. The computer program products of claim 9 further comprising computer-executable instructions for determining the account information of the payment receiver based at least in part on alias information the user provides regarding the payment receiver.

12. The computer program products of claim 11, wherein alias information comprises personal identification information about the payment receiver, such that the alias is unique to the payment receiver.

13. The computer program products of claim 9 further comprising computer-executable instructions for determining an association between the user and the payment receiver based at least in part on alias information provided by the user.

14. The computer program products of claim 9, wherein the ATM is provided by a financial institution associated with at least one of the user or payment receiver or both the user and payment receiver.

15. The computer program products of claim 9 further comprising computer-executable instructions for transferring of a payment from an account associated with the user to an account associated with the payment receiver is based at least in part on the payment receiver responding to the payment notification indicating authorization to receive payment.

16. The computer program products of claim 9, wherein the transferring of a payment from an account associated with the user to an account associated with the payment receiver is provided though an ATM system.

17. A system for providing payments via an ATM, the system comprising:
a computer apparatus including a processor and a memory; and
an online payment module stored in the memory, executable by the processor and configured to:
receive payment instructions from a user via the ATM, wherein the payment instructions include information identifying the user, a payment amount, and a payment receiver;
determine that the payment receiver is a registered payment receiver, such that account information of the payment receiver is known to a financial institution;
communicate a payment notification to the payment receiver based on the payment receiver being the registered payment receiver; and
transfer a payment from an account associated with the user to an account associated with the payment receiver.

18. The system of claim 17 further comprising determining that the payment receiver is an entity associated with the financial institution.

19. The system of claim 17 further comprising determining the account information of the payment receiver based at least in part on alias information the user provides regarding the payment receiver.

20. The system of claim 19, wherein alias information comprises personal identification information about the payment receiver, such that the alias is unique to the payment receiver.

21. The system of claim 17 further comprising determining an association between the user and the payment receiver based at least in part on alias information provided by the user.

22. The system of claim 17, wherein the ATM is provided by a financial institution associated with at least one of the user or payment receiver or both the user and payment receiver.

23. The system of claim 17 further comprising the transferring of a payment from an account associated with the user to an account associated with the payment receiver is based at least in part on the payment receiver responding to the payment notification indicating authorization to receive payment.

24. The system of claim 17, wherein the transferring of a payment from an account associated with the user to an account associated with the payment receiver is provided though an ATM system.
